(19) United States
(12) Patent Application Publication
(10) Pub. No.: US 2009/0248612 A1
(43) Pub. Date: Oct. 1, 2009

(54) Methods, Systems, And Computer Program Products For Providing Prior Values Of A Tuple Element In A Publish/Subscribe System

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/059,249

(22) Filed: Mar. 31, 2008

(51) Int. Cl. G06F 17/30

(52) U.S. Cl. 707/1; 707/E17.001

(57) ABSTRACT

Methods and systems are described for providing prior values of a tuple element in a publish/subscribe system. In one aspect, access to a history of prior values associated with the tuple element in the publish/subscribe system is maintained, wherein the history of prior values includes a plurality of values associated with the tuple element during respective previous times. A subscription request for receiving a notification with a current value associated with the tuple element sent from a publish/subscribe subscriber is processed. Responsive to processing the subscription request, a sequence of notification messages is sent to the subscriber, each including one or more of the plurality of values associated with the tuple element during respective previous times. The sequence may be ordered based on the respective previous times.

### BACKGROUND

The need to keep up with the status, activity, availability, location, and communicate has received a lot of attention. Network monitoring systems, methods, and protocols, such as simple network management protocol (SNMP), have been used to monitor networks and attached devices. Keeping up with information and other people is an activity humans have been engaged in for thousands of years. In recent years, publication/subscribe (pub-sub) protocols have emerged and are used primarily to aid people in keeping track of current information associated with identifiable entities, referred to as principals. Senders (publishers) of messages associated with principals are not programmed to send their messages to specific receivers (subscribers). Rather, published messages are published along with an identifier of the principal, without the need to know of what (if any) subscribers there may be. Subscribers express interest in current information associated with a principal by subscribing to messages identified with an identifier of the principal, and receive messages including current information associated with the identified principal. According to pub/sub communication protocols, a pub/sub service stores information provided by a publisher for sending to a subscriber in data entities referred to as tuples.

With continued development of low cost computing systems and proliferation of computer networks, there continues to be an exponential growth in the amount and availability of information. Current pub-sub systems including presence systems provide data that is current to subscribers. When a user subscribes to an identified tuple, the user sees the current information of the tuple. In many instances, the user may need some context to fully understand the current information. The context can be in prior information in the tuple.

### SUMMARY

Methods and systems are described for providing prior values of a tuple element in a publish/subscribe system. In one aspect, access to a history of prior values associated with the tuple element in the publish/subscribe system is maintained, wherein the history of prior values includes a plurality of values associated with the tuple element during respective previous times. A subscription request for receiving a notification with a current value associated with the tuple element sent from a publish/subscribe subscriber is processed. Responsive to processing the subscription request, a sequence of notification messages is sent to the subscriber, each including one of the plurality of values associated with the tuple element during respective previous times. The sequence is ordered based on the respective previous times. In another embodiment, a subscription request is sent by a publish/subscribe subscriber to receive a notification with a current value associated with a tuple element. In response to sending the subscription request, a sequence of notification messages is received with each message including one (or more) prior values of a history of prior values associated with the tuple element. The history of prior values includes a plurality of values associated with the tuple during respective previous times.

### BRIEF DESCRIPTION OF THE DRAWINGS

Advantages of the claimed subject matter will become apparent to those skilled in the art upon reading this description in conjunction with the accompanying drawings, in which like reference numerals have been used to designate like or analogous elements, and in which:

FIG. 1 is a flow diagram illustrating a method for providing prior values of a tuple element in a publish/subscribe system according to an aspect of the subject matter described herein;

FIG. 2 is block a diagram illustrating a system for providing prior values of a tuple element in a publish/subscribe system according to another aspect of the subject matter described herein;

FIG. 3 is a block diagram illustrating an arrangement of components for providing a historical value of a tuple element of a tuple in a publish/subscribe system according to another aspect of the subject matter described herein;

FIG. 4 is a block diagram illustrating a system for presenting a historical value of a tuple element of a tuple in a publish/subscribe system according to another aspect of the subject matter described herein.

FIG. 5 is a flow diagram illustrating a method for presenting a historical tuple element value according to another embodiment of the subject matter described herein;

FIG. 6 is a block diagram illustrating an arrangement of components for presenting a historical value of a tuple element according to another embodiment of the subject matter described herein.

FIG. 7 is a block diagram illustrating an arrangement of components for presenting a historical value of a tuple element according to another embodiment of the subject matter described herein.

FIG. 8 is a block diagram illustrating a user interface for presenting a historical value of a tuple element according to another embodiment of the subject matter described herein.

### DETAILED DESCRIPTION

Well known presence protocols, such as the presence protocol portions of the extensible messaging and presence protocol instant messaging (XMPP-IM), session initiation protocol (SIP) for instant messaging and presence leveraging extensions (SIP SIMPLE), and rendezvous protocol (RVP), are used by presence services, and Jabber Software Foundation's pub/sub protocol as specified in Jabber Enhancement Proposal (XEP) XEP-0060: Publish-Subscribe specifies a general purpose publish-subscribe protocol. The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al., titled “Extensible Messaging and Presence Protocol (XMPP): Instant Messaging and Presence,” each of which are published and owned by the Internet Society and incorporated here in their entirety by reference.

Generally speaking, one or more publish/subscribe (“pub/sub”) servers are used to provide pub/sub services. The function of a pub/sub server, however, can be incorporated, either in whole or in part, into other entities. According to the presence service model described in RFC 2778, two distinct agents of a presence service client are defined. The first of these agents, called a “presentity” (combining the terms “presence” and “entity”), provides presence information to be stored and distributed by the presence service on behalf of a presence client. The second type of presence agent is referred to as a “watcher.” Watchers receive presence information from a presence service on behalf of a presence client.

The presence model of RFC 2778 describes two types of watchers, referred to as “subscribers” and “fetchers.” A subscriber requests notification from the presence service of a change in some presentity client's presence information. The presence service establishes a subscription on behalf of the subscriber to a presentity client's presence information, such that future changes in the presentity client's presence information are “pushed” to the subscriber. In contrast, the fetcher class of watchers requests (or fetches) the current value of some presentity client's presence information from the presence service. As such, the presence information can be said to be “pulled” from the presence service to the watcher.

Users of the presence service are referred to in the presence model described in RFC 2778 as principals. Typically, a principal is a person or group, but can also represent software or other resources capable of interacting with the presence service. A principal can interact with the presence system through a presence user agent (PUA) or a watcher user agent (WUA). As in the case of the presentity and watcher clients with which these service clients interact, the presentity and watcher user agents can be combined functionally as a single user agent having both the characteristics of the presentity and watcher user agents. User agents can be implemented such that their functionality exists within a presence service, external to a presence service, or a combination of both. Similar statements can be made about presentities and watchers.

By way of example, exemplary aspects described here can employ a presence protocol as the pub/sub communication protocol. It should be understood, however, the relevant techniques described here can be performed using any pub/sub communications protocol as defined herein. Additionally, the exemplary aspect described herein is not limited to the use of a pub/sub protocol for all communications described.

According to pub/sub communication protocols, a pub/sub service receives information provided by a publisher and transmits the information to subscribers in data entities referred to as tuples. As stated above, a tuple, in its broadest sense, is a data object containing one or more elements. If a tuple contains a status element it is referred to as a presence tuple (RFC 2778) and the information stored in the status element is referred to as presence information. A pub/sub service which processes presence tuples is referred to as a presence service. In addition to containing a status element, a presence tuple can include any other content.

A tuple can represent any element used to transmit and/or store the published information associated with a publisher or principal. The published information may include general contact information of the publisher, such as name, telephone number, email address, postal address, an Internet protocol (IP) addresses or uniform resource locators (URLs) associated with the publisher, and the like, as well as other data or content.

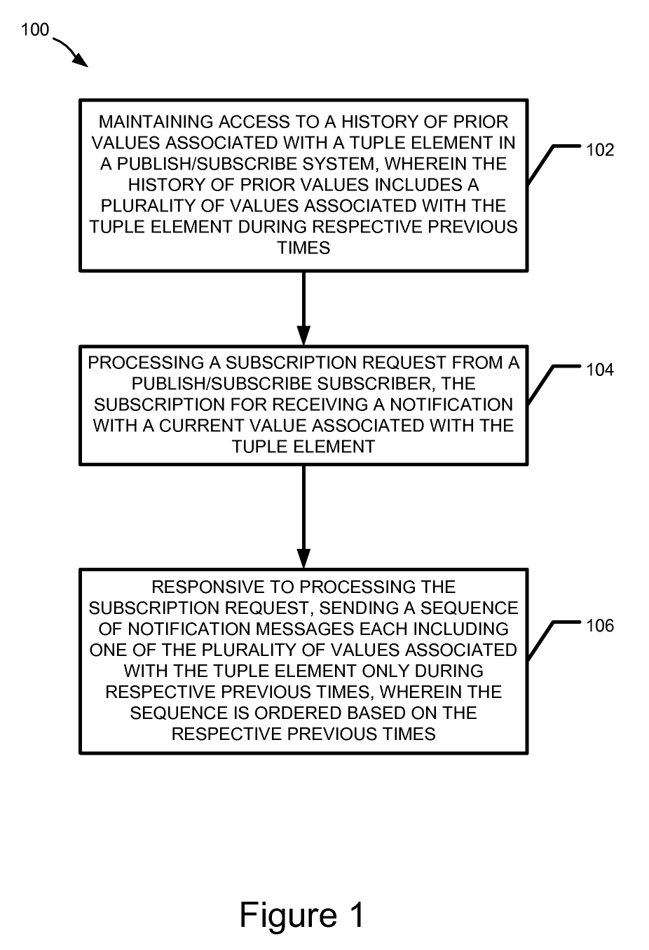

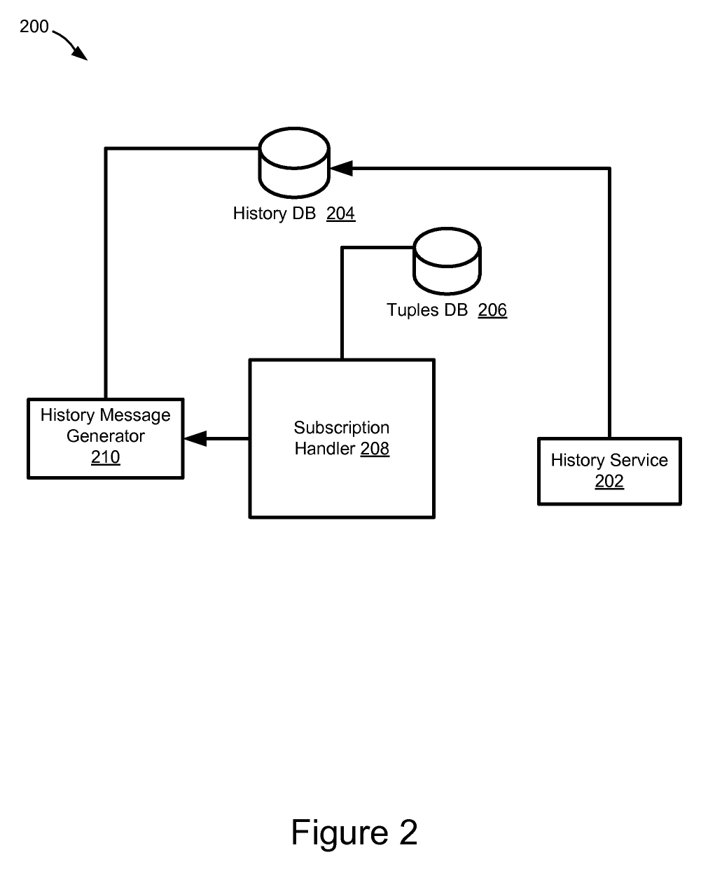

FIG. 1 is a flow diagram illustrating a method 100 for providing prior values of a tuple element of a tuple in a publish/subscribe system according to an exemplary aspect of the subject matter described herein. FIG. 2 is a block diagram illustrating a system 200 for providing prior values of a tuple element in a publish/subscribe system according to another exemplary aspect of the subject matter described herein. The method illustrated in FIG. 1 can be carried out by, for example, some or all of the components illustrated in the exemplary system of FIG. 2.

With reference to FIG. 1, in block 102 access to a history of prior values associated with the tuple element in the publish/subscribe system is maintained. The history of prior values includes a plurality of values associated with the tuple element during respective previous times. Accordingly, a system for providing prior values of a tuple element in a publish/subscribe system includes means for maintaining access to the history of prior values associated with the tuple element in the publish/subscribe system. For example, as illustrated in FIG. 2, a history service component 202 is configured for maintaining access to a history of prior values associated with the tuple element in the publish/subscribe system. The history of prior values includes a plurality of values associated with the tuple element during respective previous times.

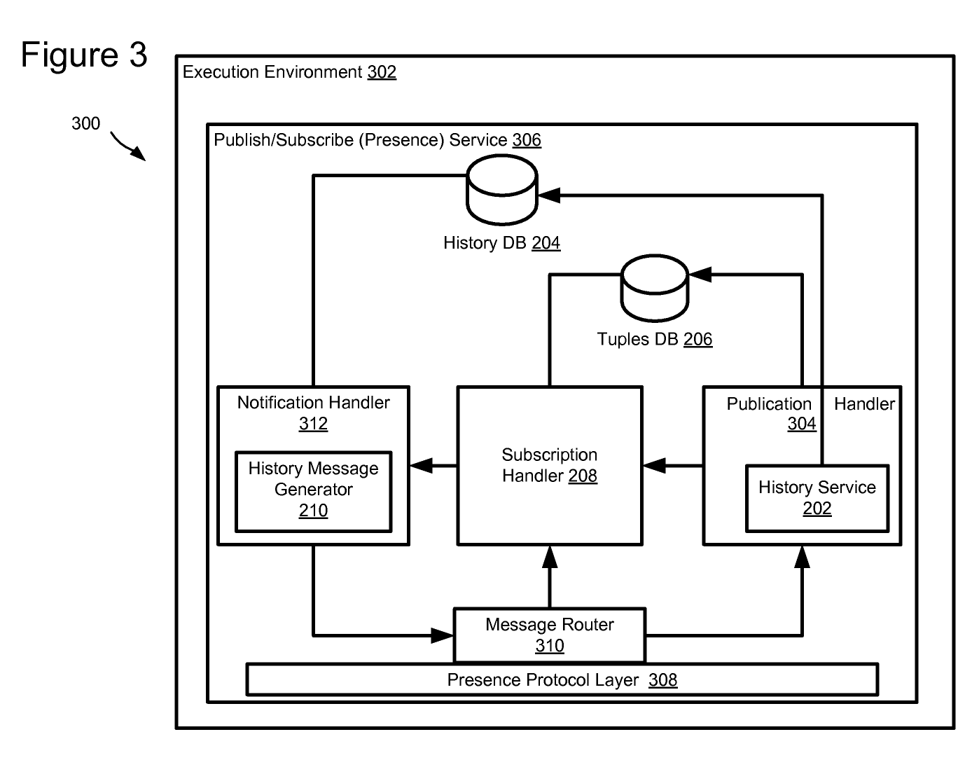

The history service 202 is configured for detecting that update information for a tuple element has been received. The history service 202 operates within an execution environment such as execution environment 302 as do the other components of the system 200. The update can be received by a publication handler 304 included in a publish-subscribe service 306 such as a presence service, as illustrated in the arrangement 300 in FIG. 3. The update information can be received via an asynchronous messaging protocol such as a presence protocol supported by presence protocol layer 308 or other real-time publish-subscribe protocols.

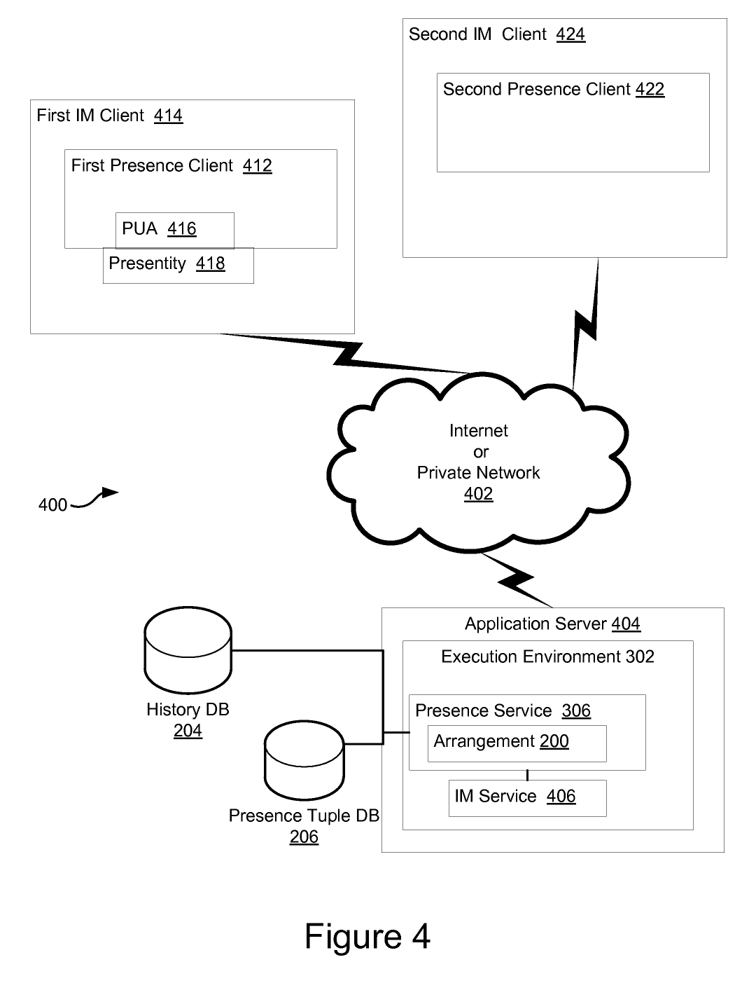

For example, publish-subscribe service (PSS) 306 may include a message router 310 configured for receiving the publish message that includes the update information. The publish message can be received via a network 402 from a first presence client 412 included in a first instant message client 414 as depicted in the arrangement 400 in FIG. 4. The first presence client 412 may include a presence user agent (PUA) 416 that provides an interface to a principal associated with a tuple. Update information can be received via the interface by the PUA 416 for updating the tuple. The PUA 416 provides the update information to a presentity 418. The presentity 418 can generate a message, such as a publish message, in accordance with the protocol(s) supported by the presence service 306. The presentity 418 can transmit the publish message over the network 402 via resources, such as a network stack (not shown), available in an associated execution environment of first message client 414. Note that the inclusion of a presence client in an IM client is merely illustrative. Presence clients can co-exist with many types of clients and can operate as stand-alone clients of a presence service.

In one embodiment, the publish message is sent over the network 402 to an application server 404. The application server 404 is configured to provide the execution environment 302. The message router 310 is configured to route message information to various components of the presence service 306 based on message type. The message router 310 can route publish messages to the publication handler 304 that is configured for updating the tuple element in a tuple identified by the publish message and stored in tuple database 206. The tuple element is updated based on the update information. The publication handler 304 can be configured for providing a current value in the tuple element to the history service 202 as a history value. The publication handler 304 can update the tuple element with a new current value included in the update information.

The history service 202 maintains access to a history of values associated with the tuple element stored in a history database 204. If history values do not exist, the history service 202 can be configured to create a history record, also referred to as a history tuple, in the history database 204. The history tuple is maintained for storing and accessing history values associated with the tuple element, which were current values during respective previous times. When a history tuple exists, the history service 202 stores the history value provided by the publication handler 304 in the history tuple for maintaining access to the history of values associated with the tuple element. The history tuple can be configured for storing one or more history values for maintaining a history of values associated with the tuple element during respective previous times. Whether a tuple element is associated with a history of values can be determined based on user input and/or configuration of the history service 202. Mechanisms for receiving user input can include receiving via a message, a user interface, and/or a data store.

The history of values stored can be limited by the configuration of the history service 202 and/or the history database 204. The configuration can be established via a user interface and/or a configuration data store by a user, such as an administrator of the PSS 306. Additionally or alternatively, configuration information for maintaining a history of values in a history tuple can be received via a message from a network node such as the first presence client 412. Authorization can be required for establishing configuration information for a history tuple associated with a tuple element. For example, a principal or owner of the tuple element can be authorized to establish the configuration information.

In one aspect, history values are maintained on a per tuple element basis. A tuple element can have one associated history tuple or no history tuples. Alternatively, the history service 202 can be configured for maintaining access to a history tuple associated with a tuple element for each subscriber to the tuple element. A subscriber to the tuple element can be allowed to activate and deactivate maintaining access to a history of values for the subscriber.

The tuple element associated with the history of values can be included in a plurality of tuple elements in a tuple. Each value in the history of values can be associated with a tuple element in the plurality of tuple elements during a respective previous time. The history service 202 can be configured for maintaining access to a history of values including values from the plurality of tuple elements. For example, values associated with a status tuple element, a location element, and a current device element can be included in a presence tuple for a principal. A history tuple can be established and maintained by the history service 202. The history service 202 can store a history of values associated with updates to each of the elements in the history tuple. Each update in a previous respective time can result in storing only updated values from the three elements, or values from all three tuple elements can be stored in the history of values each previous respective time any of the tuple elements is updated.

The history service 202 can also be configured for maintaining access to a history of values associated with a plurality of tuple elements included in a plurality of tuples at previous respective times. For example, a status tuple element can be included in a presence tuple for each member of a group of principals. A history of the status values associated with the status tuple elements in the presence tuples associated with the members of the group can be stored in single history tuple. Additionally, a history across a plurality of tuples can be maintained as a history of values in a single history tuple. Similarly, a history across a plurality of tuple elements from a plurality of tuples can be maintained where at least some of the tuple elements are from different tuples storing different types of values and or storing values with different meanings and/or for different purposes. A history tuple can be associated with the plurality, allowing a history of a diverse set of tuple elements from multiple tuples to be maintained. The tuples including the history tuple elements can have different formats. Those skilled in the art can see that as many history tuples with any mix of tuple elements from any mix of tuples as required by various users can be maintained for access by the history service 202 in the history database 204.

Configuration information associated with a tuple element can include information for determining a maximum number of history values that can be stored in an associated history tuple. Alternatively or additionally, the configuration can include information for establishing a time interval for limiting the respective previous times in an associated history tuple. For example, configuration information can include a two hour time interval during which updates to the tuple element are stored in a history value. A history tuple can be frozen when a limit and/or maximum is met, allowing no further updates. Alternatively, history values can be discarded from a history tuple as new history values are stored in the history tuple. The history values discarded can be based on a policy such as a first-in, first-out (FIFO) policy.

Returning to FIG. 1, in block 104 a subscription request is processed from a publish/subscribe subscriber. The subscription request is for receiving a notification with a current value associated with the tuple element. Accordingly, a system for providing prior values of a tuple element in a publish/subscribe system includes means for processing a subscription request from a publish/subscribe subscriber, the subscription for receiving a notification with a current value associated with the tuple element. For example, as illustrated in FIG. 2, a subscription handler component 208 is configured for processing a subscription request from a publish/subscribe subscriber, where the subscription is for receiving a notification with a current value associated with the tuple element.

A subscription request can be received by the subscription handler 208 from the message router 310 that is configured to route messages based on message type as described above. The message router 310 can receive the subscription request generated by a publish-subscribe client, such as a second presence 422 included in a second IM Client 424 as depicted in FIG. 4. The presence client 422 can provide an identifier of the tuple, such as a tuple published by the first presence client 412, and optionally identifiers for one or more subtuples (i.e., tuple elements) in the subscription request. The second presence client 422 can be configured to generate a subscription request in a format compatible with a protocol supported by a protocol layer of the presence service 306, such as the presence protocol layer 308 described above.

The subscription handler 208 can be configured to associate a subscription based on the subscription request with the identified tuple in the subscription request, such as, for example, the tuple associated with the first presence client 412. The subscription handler 208 can add an entry to a subscription list based on the subscription request. The subscription can identify the subscriber, the second presence client 422, and some or all of the tuple elements in the tuple for receiving a notification with a current value for some of or all of the tuple elements.

The subscription handler 208, optionally interacting with a notification handler 312, can determine, based on the subscription request, a tuple element in the identified tuple associated with a history of values. For example, the subscription handler 208 can determine whether a history tuple in the history database 204 is associated with a tuple element in the tuple identified by the subscription request. The subscription handler 208 can be further configured for determining based on the subscription request that a sequence of notifications is to be sent. For example, the subscription handler 208 can determine whether a tuple element subscribed to is associated with the history of values in the associated history tuple. The determination result can indicate whether a sequence of notification messages is to be sent. For example, if the determination is that a history tuple with a history of values exists in association with a tuple element associated with the subscription request, then the sequence of notification messages is to be sent.

The subscription handler 208 and/or the notification handler 312 can determine whether there is a limit associated with values in the history of values to be sent in the sequence of notification messages associated with the tuple element. The limit can be determined based on a configured maximum number and/or on a time interval identifying one or more respective times associated with values to be sent. For example, the limit can be retrieved from a configuration associated with the particular tuple element, all similar tuple elements, and/or all tuple elements. The configuration can apply to one or more tuples included in the tuple database 206. Alternatively or additionally, the determination can be based on the subscription request. For example, a limit can be included in the subscription request and/or a limit can be associated with a configuration identified by a tuple identifier included in the subscription request.

The presence client 422 can provide for including an indication in the subscription request message that indicates a request to maintain access to a history of values for one or more identified tuple elements. When no tuple element identifier is provided with the indication, the tuple identifier of the subscription request is associated with the indication. The subscription handler 208 can be configured to detect the indication in the subscription request. In response to detecting the indication, the subscription handler 208 can create a history tuple for maintaining a history of values. Alternatively, the subscription handler 208 can be configured to interpret a subscription request associated with a tuple element as an indication that a history of values associated with the tuple element is to be maintained.

When a history tuple for maintaining access to a history of values associated with the tuple element exists, the subscription handler 208 can be configured for ending maintaining access to archivable values associated with subsequent updates to the tuple element when a subscription request is processed. This may be particularly useful when history tuples are kept for a particular presence client. When a presence client has an active subscription, there may be no need to continue maintaining access to a history of values for the presence client since the presence client is sent a notification associated with each update to the tuple element. When the subscription is disabled, the subscription handler 208 can restart the storing of history values in an associated history tuple.

An arrangement of components is configured for maintaining a tuple associated with the processing of subscription requests. The subscription handler 208 can interoperate with the publication handler 304 to update a tuple element in the tuple associated with the processing of subscription requests. As with any tuple element, the subscription handler 208 can associate a history tuple with a tuple element in a tuple associated with the processing of subscription requests. Similar tuple elements can be provided and associated with processing of other messages, events, and any other unit of processing. A tuple associated with the presence service as principal can include tuple elements of this type, for example.

Returning to FIG. 1, in block 106 responsive to processing the subscription request, a sequence of notification messages is sent, each including one of the plurality of values associated with the tuple element during respective previous times. The sequence is ordered based on the respective previous times. Accordingly, a system for providing prior values of a tuple element in a publish/subscribe system includes means for responsive to processing the subscription request, sending a sequence of notification messages each including one of the plurality of values associated with the tuple element during respective previous times. For example, as illustrated in FIG. 2, a history message generator component 210 is configured for sending a sequence of notification messages in response to the subscription request being processed. Each notification message in the sequence of messages includes one or more of the plurality of values associated with the tuple element during respective previous times. In one aspect, the sequence is ordered based on the respective previous times.

In the arrangement 200, the subscription handler 208, in processing the subscription request, can provide history information identifying the updated tuple and/or the history tuple associated with the tuple element to the history message generator 210. The history information can identify one or more history values in the history of values associated with the tuple element. In response to receiving the history information, the history message generator 210 can retrieve one or more values in the history of values for sending in a notification message included in a sequence of notification messages. The history message generator 210 can generate a notification message including one or more of the values in the history of values stored in the history tuple associated with the tuple element. Each value in the history of values is associated with the tuple element along with a previous time, such as a time when the value was a current value of the tuple element, a time the value became a current value of the tuple element, and/or a time when the value became a value in the history of values. The notification message is sent to a client, such as the presence client that sent the subscription request (e.g., presence client 422). The process of retrieving one or more of the sequence of values in the history of values associated with the tuple element, generating one or more notification messages where each notification message includes one or of the retrieved values, and sending the one or more messages can be repeated for at least some of the values in the history of values. For example, a determination can be made to determine which values in the history of prior values have not been sent to the publish/subscribe subscriber. The values which have not been sent are sent to the publish/subscribe subscriber. The messages are sent as a sequence of notification messages. In one aspect, the sequence is ordered based on the respective previous times of the values in the history of values. A notification message can include more than one value from the history of values. When more than one value is included in a notification message, an indicator of an order of the values based on their respective previous times is also provided. The order can be indicated by a field in the notification message for storing an order indicator and/or can be indicated by a position of each value in a notification message.

In one alternative, one or more of the values included in the sequence of notification messages are sent to a client for presentation by the receiving client. For example, in FIG. 4, a subscription request sent via the second presence client 422 can be processed by the subscription handler 208. In response to processing the subscription request for receiving a notification message including a current value associated with the tuple element, the history message generator 210 can send a sequence of notification messages including a plurality of values from a history of values associated with a tuple element. The notification messages can be sent via the network 402 to the second presence client 422. The second presence client 422 can be configured to present the current value of the tuple element in correspondence with presenting the one or more of the values in the history of values received in the sequence of notification messages. The values in the history of values received can be presented in an order based on their respective previous times. This type of presentation presents a viewer with the current value of the tuple element associated with the principal of the first presence client 412 in a context indicating at least some of the previous values of the tuple element. A respective time can be included in a notification message along with its associated value in the history of values by the message history generator 210. The respective time can be displayed along with the received value in the history of values by the receiving client. For example, a second user of the second IM client 424 can be presented with a current status of a first user of the first IM client 414 as “online”. The corresponding presentation of the history of values can indicate that the first user has been in a meeting for over three hours before the first user's status change to “online” less than 3 minutes ago.

Further, the history message generator 210 can be configured for sending the sequence of messages where a first message and a second message are sent at a time interval determined by the history message generator 210. The time interval may be based on a mathematical relationship between the determined time interval and a time interval defined by the respective previous time associated with a history value in each of the first message and the second message. Each message can be sent in a sequence at time intervals that are mathematically related to the respective previous times of the values sent. For example, a sequence of times for sending can have a sequence of time intervals between each pair of sending times where the sequence of time intervals is the same as the time intervals between the respective times of a history value included in each notification message sent. Alternatively, the sequence of messages can be sent at a faster rate than notifications with current values are sent.

The sending time intervals can be proportional to the respective previous time intervals. Alternatively, the sending time intervals can be reduced or increased either at a continuous rate or at discrete points in the sending of the messages. For example, for a large number of values, values can be presented relatively briefly towards the beginning of the sequence of presentations with respect to presentations towards the end of the sequence of presentations. Alternatively or additionally, a time interval can be determined for indicating a time interval between presenting two of the values sent. The determined time interval associated with presenting the two values can be mathematically related to the respective previous times associated with the two values sent. The received time intervals allow the client to more accurately present the values as intended by the history message generator 210. A presenting client can be configured to present the values in any way that it is configured to present them regardless of order and/or time of reception, and/or any indication of order and/or time of presentation from the sender.

As described above, the subscription handler 208 can detect an indicator in the subscription request for sending the sequence of notification messages including values in the history of values. Alternatively, the subscription handler 208 in processing the subscription request can interoperate with the history message generator 210 for automatically sending the sequence of messages to a recipient without an indicator or request included in the subscription request for sending the sequence of notification messages to the recipient.

The history message generator 210 can be configured to send only a portion of the values in the history of values as previously described. Those skilled in the art will understand that there are a variety of mechanisms for reducing the number of values, and subsequently, the number of messages in the sequence for sending. For example, a pattern of values in a first sequence in the history of values can be associated with a second sequence of values where the length of the second sequence is less than length of the first sequence. The length of the second sequence can be one for providing a single value in the history of values for representing the associated pattern. The length of the second sequence can be zero when a pattern in a sequence of values is configured as unnecessary for maintaining. In this case, the first sequence of values can have a length of one or greater. Additionally or alternatively, values of a specified type and/or within a specified range or set or time can be configured for sending or for not sending. Time intervals can be configured where values with respective previous times in the time interval are not sent while others are sent, or vice versa. A configuration for determining values in a history of values to be included or excluded from a sequence of notifications messages can have a variety of scopes including a scope applied for all tuple elements in the tuple database 206, on a per principal basis, a per subscriber basis, a per subscription basis, a per tuple basis, and/or a per tuple element basis.

Alternatively or additionally, the history message generator 210 can be configured to compress the values in one or more tuple elements. A number of variations exist. For example, for partial tuple updates, a notification can combine subtuples that update distinct portions of the tuple. Tuples can be sent based on the tuple information as logged at regular intervals. That is, the historical notifications don't directly correspond to published information. For example, in one aspect, a summary of the history of prior values is sent in place of the sequence of notification messages in response to a subscriber requesting a summary of the history of a tuple element.

To further reduce message traffic, the history message generator 210 interoperating with the notification handler 312 can include a current value in the tuple in a notification message in the sequence. When an element of the tuple associated with the sequence of notification message is updated, the new current value can be included in a notification message in the sequence along with one or more values from the history of values associated with the tuple. The updated tuple element can be the tuple element associated with the history of values. Some or all of the tuple can be included in the notification message in the sequence. Responsive to processing the subscription request, some or all of the current values in the tuple can be sent in one of the notification messages in the sequence. The first and the last notification messages in the sequence are expected to typically include some or all of the current values in the tuple when this feature is supported. Alternatively, a current value of an element in the tuple can be sent in a notification message not included in the sequence. Such a notification message can be sent before, during, and/or after the sending of the sequence of notification messages.

Client Method and System

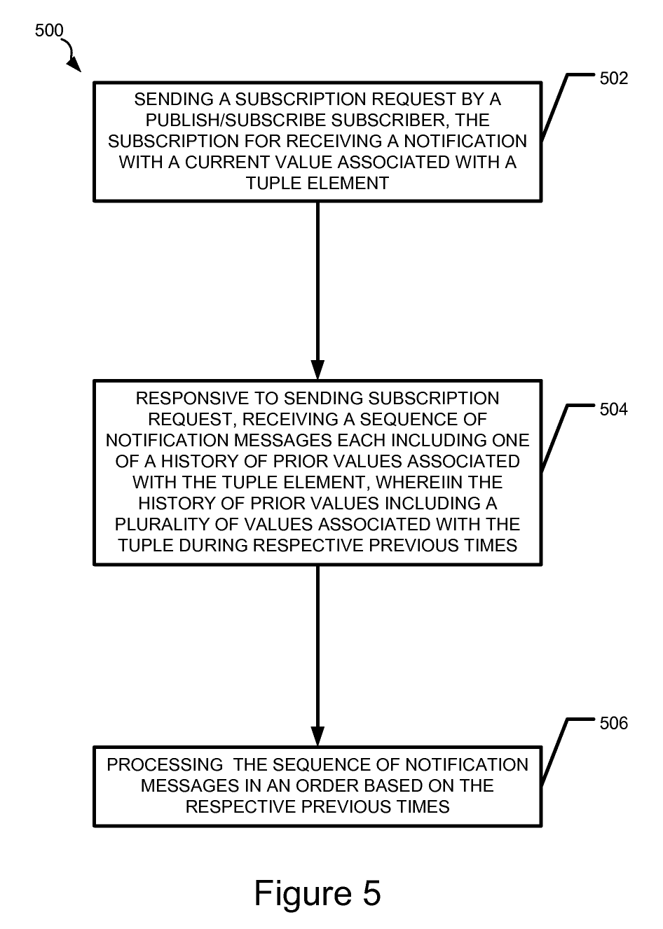

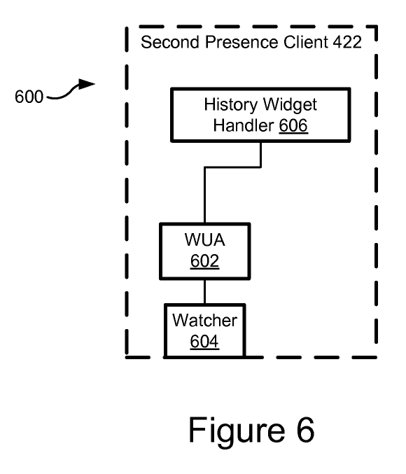

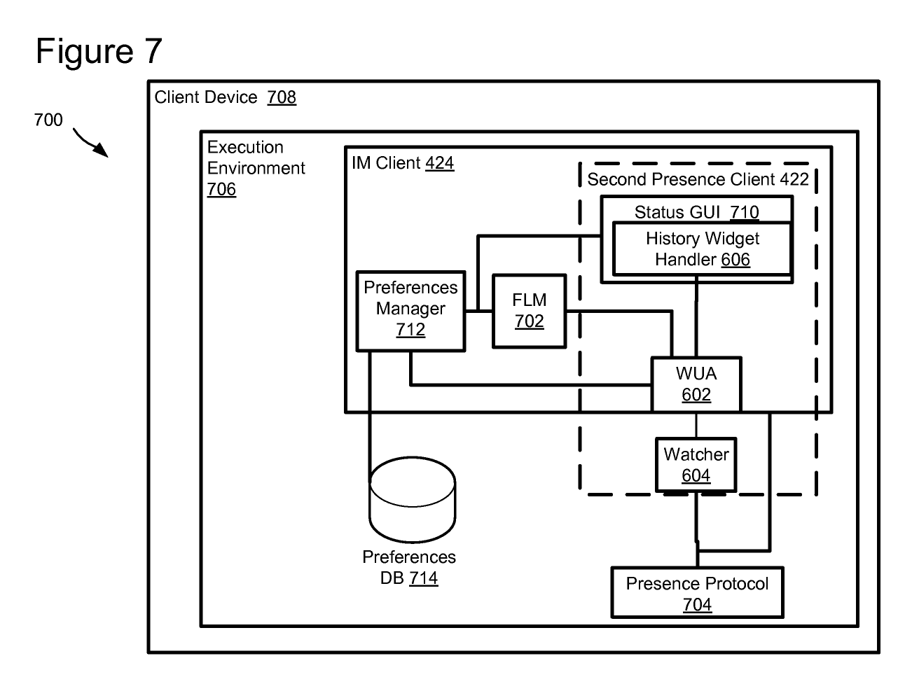

FIG. 5 is a flow diagram illustrating a method 500 for presenting a historical value of a tuple element of a tuple in a publish/subscribe system according to an exemplary aspect of the subject matter described herein. FIG. 6 is a block diagram illustrating a system 600 for presenting a historical value of a tuple element of a tuple in a publish/subscribe system according to another exemplary aspect of the subject matter described herein. FIG. 7 is an exemplary arrangement 700 of components for hosting the arrangement 600 for presenting a historical tuple element value according to another exemplary embodiment of the subject matter described herein. The method illustrated in FIG. 5 can be carried out by, for example, some or all of the components illustrated in the exemplary system of FIG. 6 operating in an arrangement, such as the arrangement 700 of FIG. 7, configured for hosting the system of FIG. 6.

With reference to FIG. 5, in block 502 a subscription request is sent by a publish/subscribe subscriber, where the subscription request is for receiving a notification with a current value associated with a tuple element. Accordingly, a system for presenting a historical value of a tuple element of a tuple in a publish/subscribe system includes means for sending a subscription request by a publish/subscribe subscriber, the subscription for receiving a notification with a current value associated with a tuple element. For example, as illustrated in FIG. 6, a watcher 604 component is configured for sending a subscription request by a publish/subscribe subscriber, the subscription for receiving a notification with a current value associated with a tuple element.

Turning now to FIG. 6, a WUA 602 operating in the second presence client 422 can be configured for receiving an indication to subscribe to a specified tuple. The WUA 602 can invoke a watcher 604 for generating a subscription request for a tuple identified by the indication. The WUA 602 can be called to subscribe to a presence tuple of, for example, the principal of the first presence client 412 by a friends list manager (FLM) 702 in the presence client 422. The watcher 604 can generate the subscription request in a format compatible with communicating with a subscription service, such as the presence service 306 operating in the application server 404. The watcher 604 sends the subscription request to establish a subscription for receiving a notification with a current value associated with a tuple element included in a tuple identified in the subscription request. The watcher 604 can send the subscription request via an asynchronous messaging protocol such as a presence protocol supported by a presence protocol layer 704 included in an execution environment 706 provided by a client device 710. The execution environment 706 is configured for hosting the arrangement 600 of components.

The subscription request generated by the watcher 604 can include a history request including an indication for receiving a sequence of values from a history of values associated with a tuple element included in the tuple identified in the subscription request. The sequence of values can be included in a sequence of notification messages received by the WUA 602 via the watcher 604. The history request can identify one or more tuple elements for receiving one or more sequences of notification messages. Alternatively, the determination to send the sequence of values in the history of values can be left to the presence service 306.

The watcher 604 can include information in the history request limiting the values in the history of values to be received. The limiting information can be provided to the watcher 604 by the WUA 602 as received from a preferences manager 712. The limiting information can be stored in a preferences database 714. The limiting information can include a maximum number of values in the history of values to be sent. Alternatively or additionally, the limiting information can include a specified time interval for limiting the respective previous times associated with the values to be sent.

The watcher 604 can include a request in the message with the subscription request to maintain access to a history of values associated with an identified tuple element and/or can send the request to maintain access in another message. Alternatively, the watcher 604 can include a request to stop maintaining access to a history of values associated with an identified tuple element in a message including the subscription request and/or can sent the request to stop in another message.

Returning to FIG. 5, in block 504 responsive to sending the subscription request, a sequence of notification messages is received, each including one of a history of prior values associated with tuple element where the history of values includes a plurality of values associated with the tuple during respective previous times. Accordingly, a system for presenting a historical value of a tuple element of a tuple in a publish/subscribe system includes means for responsive to sending the subscription request, receiving a sequence of notification messages each including one of a history of prior values associated with tuple element, the history of values including a plurality of values associated with the tuple during respective previous times. For example, as illustrated in FIG. 5, a watcher user agent (WUA) 602 component is configured for receiving a sequence of notification messages responsive to sending the subscription request where each notification message includes one of a history of prior values associated with tuple element, the history of values including a plurality of values associated with the tuple during respective previous times.

In the arrangement 600, in response to sending the subscription request, the WUA 602 receives a sequence of notification messages. Each notification message includes a value from the history of values associated with the tuple element ordered as described above. Each notification message can be sent by the history message generator 210 as described above via the network 402 for receiving by the protocol layer 704 hosted by the execution environment 706 of a client device 708.

The protocol layer 704 can provide for receiving a notification message in the sequence via an asynchronous protocol as indicated above. The asynchronous protocol can be a publish-subscribe protocol such as a presence protocol.

Returning to FIG. 5, in block 506 each of the plurality of values received in an order based on the respective previous times is processed. Accordingly, a system for presenting a historical tuple element value includes means for processing each of the plurality of values received in an order based on the respective previous times. For example, as illustrated in FIG. 6 a history widget handler 606 component is configured for processing each of the plurality of values received in an order based on the respective previous times.

For example, in the arrangement 600 the WUA 602 can provide a value in the history of values from a notification message to the history widget handler 606 for a client of the WUA 602 for processing. For example the FLM 702 can be a client of the WUA 602. The FLM 702 based on tuple information provided by the WUA 602 can associate the historical value with a watched friend and provide the historical value to the history widget handler 606 for presenting.

The widget handler 606 and/or the FLM 702 can further process the value in the history of values in correspondence with processing a current value of the associated tuple element. The FLM 702, in one example of processing values received in the sequence of messages, can invoke the status GUI 710 to update a presentation of tuple information for a watched friend. For example, a current value of a tuple element, such as a status value received in a notification message can be presented to the second user of the IM client 424 by the status GUI 710 of the presence client 422.

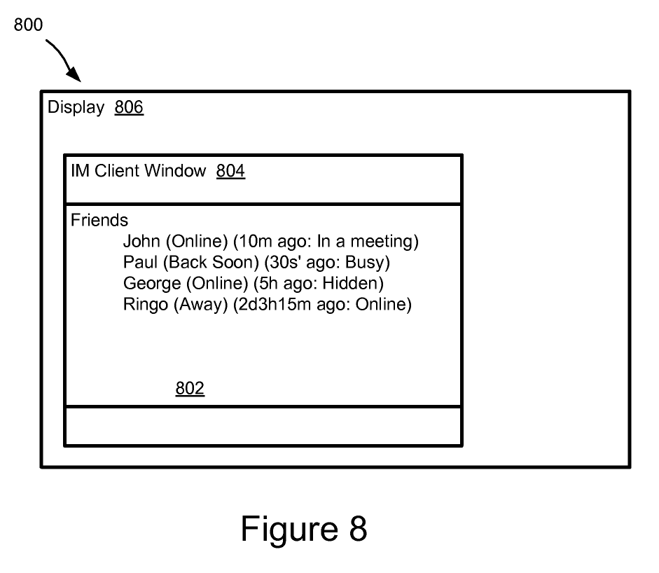

An exemplary user interface 800 presentable by the status GUI 710 is illustrated in FIG. 8. The status GUI 710 presents a “Friends” widget 802 in an IM client window widget 804 on a display 806. The Friends widget 802 presents the current status of the second user's friends; John, Paul, George, and Ringo. Their current statuses are depicted as “Online”, “Back Soon”, “Online”, and “Away”, respectively.

The status GUI 710 can include a history widget handler 606 for presenting one or more values in the history of values in correspondence with presenting a current value. In the “Friends” widget 802 a value from a history of values associated with a status tuple element is presented for each friend. For example, as indicated, John's current status is “Online”. The history widget handler 606 can be configured for receiving time information along with a history value. In the user interface 800, the history widget handler 606 can present a history value and a respective time and/or time interval when the history value was a current value. For example, the history widget handler 606 presents text indicating John was “In a meeting” ten minutes previous from the present time. History value indications are presented, similarly, for Paul, George, and Ringo by the history widget handler 606 in the “Friends” widget 802. Some or all of the values in the history of values received can be presented in an order based on the respective previous times of each of the values presented. To aid in this presentation, the sequence of values can be received in an order based on the respective previous times of the history values included in the notification messages and/or time information based on the respective previous time associated with each value can be included in each received notification message.

The history widget handler 606 and the status GUI 710 can be configured further for presenting some or all of the values in the history of values received where time intervals between the presentation of two successive history values is mathematically related to respective time intervals between two respective previous times associated with the two successive history values as previously described.

As described above with respect to sending a current value by the notification handler 312, a current value of an element in the tuple that includes the tuple element associated with the history of values can be sent to the WUA 602 in a notification message. The notification message including the current message can be a notification message not included in the sequence of notification messages including values in the history of values. The notification message including a current value can be received by the WUA 602 before, during, and/or after the WUA 602 receives the sequence of notification messages. Alternatively or additionally, a current value as defined in the previous paragraph can be received in a notification message included in the sequence of notification messages

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, the methods described herein can be embodied in executable instructions stored in a computer readable medium for use by or in connection with an instruction execution machine, system, apparatus, or device, such as a computer-based or processor-containing machine, system, apparatus, or device.

As used here, a “computer readable medium” can include one or more of any suitable media for storing the executable instructions of a computer program in one or more of an electronic, magnetic, optical, electromagnetic and infrared form such that the instruction execution machine, system, apparatus, or device can read (or fetch) the instructions from the computer readable medium and execute the instructions for carrying out the described methods. A non-exhaustive list of the conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a Blu-ray™ disc; and the like.

Thus, the subject matter described herein can be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing prior values of a tuple element in a publish/subscribe system, the method comprising:
maintaining access to a history of prior values associated with the tuple element in the publish/subscribe system, wherein the history of prior values includes a plurality of values associated with the tuple element during respective previous times;
processing a subscription request from a publish/subscribe subscriber, the subscription for receiving a notification with a current value associated with the tuple element; and
responsive to processing the subscription request, sending a sequence of notification messages each including one or more of the plurality of values associated with the tuple element during respective previous times, wherein the sequence is ordered based on the respective previous times.

2. The method of claim 1 wherein sending the sequence of notification messages comprises sending the sequence of notification messages using a presence protocol.

3. The method of claim 1 wherein the history of prior values is limited by at least one of a maximum number of prior values and a time interval for limiting the respective previous times.

4. The method of claim 1 wherein the tuple element comprises a plurality of tuple elements of a tuple, and wherein the history of prior values includes values for each tuple element in the plurality of tuple elements at a respective previous time.

5. The method of claim 1 wherein sending the sequence of notification messages comprises sending the sequence of notification messages at a faster rate than notifications with current values are sent.

6. The method of claim 5 wherein the faster rate is based upon a time interval between the sending of a notification message and the receipt of the notification message by the publish/subscribe subscriber.

7. The method of claim 1 wherein processing the subscription requests includes determining which values in the history of prior values have not been sent to the publish/subscribe subscriber and sending the sequence of notification messages comprises sending notification messages that include the values in the history of prior values that have not been sent to the publish/subscribe subscriber.

8. The method of claim 1 wherein the respective previous times are within a fixed time set by the publish/subscribe subscriber.

9. The method of claim 1 wherein the plurality of values sent in the sequence of notification messages comprises compressed values.

10. A method for presenting a historical value of a tuple element of a tuple in a publish/subscribe system, the method comprising:
sending a subscription request by a publish/subscribe subscriber, the subscription for receiving a notification with a current value associated with a tuple element;
responsive to sending the subscription request, receiving a sequence of notification messages each including one or more of a history of prior values associated with tuple element, the history of prior values including a plurality of values associated with the tuple during respective previous times; and
processing the sequence of notification messages in an order based on the respective previous times.

11. The method of claim 10 wherein sending the history request includes sending information limiting the values in the history of prior values to be received by specifying at least one of a maximum number of values and a specified time interval for limiting the respective previous times of the values to be sent.

12. The method of claim 10 further comprising requesting a summary of the history of prior values in place of the sequence of notification messages.

13. The method of claim 10 wherein receiving the sequence of notification messages comprises receiving the sequence of notification messages via an asynchronous message protocol.

14. The method of claim 10 further comprising:
presenting the current value; and
presenting, in correspondent with presenting the current value, at least a portion of the sequence of values received in an order based on the associated respective times of each of the values presented.

15. The method of claim 10 wherein each notification message includes time information based on a respective previous time associated with the one of the history of prior values.

16. A system for providing prior values of a tuple element in a publish/subscribe system, the system comprising:
means for maintaining access to a history of prior values associated with the tuple element in the publish/subscribe system, wherein the history of prior values includes a plurality of values associated with the tuple element during respective previous times;
means for processing a subscription request from a publish/subscribe subscriber, the subscription for receiving a notification with a current value associated with the tuple element; and
means for responsive to processing the subscription request, sending a sequence of notification messages each including one or more of the plurality of values associated with the tuple element during respective previous times, wherein the sequence is ordered based on the respective previous times.

17. A system for providing prior values of a tuple element in a publish/subscribe system, the system comprising:
a history service component configured for maintaining access to a history of prior values associated with the tuple element in the publish/subscribe system, wherein the history of prior values includes a plurality of values associated with the tuple element during respective previous times;
a subscription handler component configured for processing a subscription request from a publish/subscribe subscriber, the subscription for receiving a notification with a current value associated with the tuple element; and
a history message generator component configured for responsive to processing the subscription request, sending a sequence of notification messages each including one or more of the plurality of values associated with the tuple element during respective previous times, wherein the sequence is ordered based on the respective previous times.

18. The system of claim 17 wherein the history message generator component is configured to send the sequence of notification messages using a presence protocol.

19. The system of claim 17 wherein the history service component is configured to limit the history of prior values by at least one of a maximum number of prior values and a time interval for limiting the respective previous times.

20. The system of claim 17 wherein the history message generator component is configured for sending the sequence of notification messages at a faster rate than notifications with current values are sent.

21. The system of claim 17 wherein the subscription handler component is configured for determining which values in the history of prior values have not been sent to the publish/subscribe subscriber and sending the sequence of notification messages comprises sending notification messages that include the values in the history of prior values that have not been sent to the publish/subscribe subscriber.

22. A computer readable medium embodying a computer program, executable by a machine, for providing prior values of a tuple element in a publish/subscribe system, the computer program comprising executable instructions for:
maintaining access to a history of prior values associated with the tuple element in the publish/subscribe system, wherein the history of prior values includes a plurality of values associated with the tuple element during respective previous times;
processing a subscription request from a publish/subscribe subscriber, the subscription for receiving a notification with a current value associated with the tuple element; and
responsive to processing the subscription request, sending a sequence of notification messages each including one or more of the plurality of values associated with the tuple element during respective previous times, wherein the sequence is ordered based on the respective previous times.
